(19) United States
(12) Patent Application Publication
(10) Pub. No.: US 2005/0130029 A1
(43) Pub. Date: Jun. 16, 2005

(54) Battery pack mounting apparatus for mobile communication terminals

(75) Inventor: Yong-hwa Kim, Seoul (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: CURITEL COMMUNICATIONS, INC., Seoul (KR)

(21) Appl. No.: 10/974,792

(22) Filed: Oct. 28, 2004

(30) Foreign Application Priority Data
Dec. 10, 2003 (KR) 10-2003-0089713

(51) Int. Cl. H01M 2/10

(52) U.S. Cl. 429/97; 429/100

(57) ABSTRACT

A battery pack mounting apparatus includes a push button and a rotary unit for locking and unlocking the battery pack to a fitting space. The push button is slidably mounted to a main body of the apparatus, which also includes a device to guide the push button. The guide device includes a guide protrusion laterally disposed on the push button, and a guide groove located at an inside surface of the main body. The rotary unit includes an actuating member for locking or unlocking the battery pack according to a movement of the push button, a rotary member for rotating the actuating member between locking and unlocking positions as the push button moves, and a resilient member for supporting the push button and returning the actuating member to its original position.

### BACKGROUND OF THE INVENTION

1. Field of the Invention

The present invention relates to a battery pack mounting apparatus for mobile communication terminals, and more particularly to a battery pack mounting apparatus for mobile communication terminals that is capable of easily and conveniently separating a battery pack from a main body of a mobile communication terminal by simply pressing a push button formed at the main body of the mobile communication terminal.

2. Description of the Related Art

A conventional battery pack mounting apparatus for mobile communication terminals is shown in FIG. 5. The conventional battery pack mounting apparatus comprises: a battery pack fitting space 301 formed at the rear part of a main body 300 of a mobile communication terminal; and a locking part 400 formed at the rear part of the main body 300 while being adjacent to the battery pack fitting space for detachably locking a battery pack 200 in the battery pack fitting space 301. When the battery pack 200 is to be separated from the main body 300, the locking part 400 is lifted upward using one hand of a user, especially a fingernail, so that the battery pack 200 is released from the main body 300, and then the battery pack is slid using the other hand of the user so that the battery pack 200 is separated from the main body 300. Consequently, the conventional battery pack mounting apparatus has a drawback in that the fingernail of the user may be injured. The conventional battery pack mounting apparatus also has a drawback in that both hands of the user are used at the same time to separate the battery pack from the main body of the mobile communication terminal.

### SUMMARY OF THE INVENTION

It is an object of the present invention to provide a battery pack mounting apparatus for mobile communication terminals that is capable of separating a battery pack from a main body of a mobile communication terminal with only one hand of a user by simply pressing a push button formed at the main body of the mobile communication terminal.

It is another object of the present invention to provide battery pack mounting apparatus for mobile communication terminals having an actuating part that can be rotated when the push button is pressed so that the battery pack is released and at the same time separated from the main body of the mobile communication terminal, whereby separation of the battery pack is more easily and conveniently achieved.

In accordance with the present invention, the above and other objects can be accomplished by the provision of a battery pack mounting apparatus for mobile communication. terminals, comprising: a push button; and a rotary locking unit rotatable by an operation of the push button for locking a battery pack to a battery pack fitting space or unlocking the battery pack from the battery pack fitting space.

Preferably, the push button is slidably mounted to the main body, and the apparatus further comprises: means for guiding a sliding movement of the push button.

Preferably, the guiding means comprises: a guide protrusion provided at a lateral part of the push button; and a guide groove provided at an inside surface of the main body to receive the guide protrusion.

Preferably, the rotary locking unit comprises: an actuating member for locking the battery pack to the battery pack fitting space or unlocking the battery pack from the battery pack fitting space according to a movement of the push button; a rotary member for rotating the actuating member between a locking position and an unlocking position on the basis of the movement of the push button; and a resilient member disposed at the rear of the push button for resiliently supporting the push button and returning the actuating member to its original position.

Preferably, the resilient member is fitted on the front outer circumference of the actuating member, the resilient member having one end supporting the inside surface of the main body and the other end fixed to the actuating member. In an embodiment, the resilient member is a torsion spring.

Preferably, the rotary member has a reciprocating inclined surface formed at the rear part of the push button and a rotating inclined surface formed at the front part of the actuating member such that the rotating inclined surface corresponds to the reciprocating inclined surface.

Preferably, the actuating member has a rotary shaft formed at the rear part thereof such that the rotary shaft can be rotatably inserted in the main body, a guide shaft formed at the front part thereof, the guide shaft being inserted in the push button for preventing separation of the push button from the actuating member, and an engagement protrusion formed at a prescribed position of the outer circumference thereof such that the engagement protrusion can be engaged in an engagement groove formed at the battery pack.

Preferably, the actuating member is provided at a prescribed position of the rear part thereof with a separation protrusion such that the separation protrusion extends outward while being spaced apart from the engagement protrusion by a prescribed angle, the separation protrusion being moved toward the battery pack fitting space as the actuating member is rotated so that the battery pack is separated from the battery pack fitting space.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view showing a battery pack mounting apparatus for mobile communication terminals according to a preferred embodiment of the present invention;

FIG. 2 is an enlarged side view of the battery pack mounting apparatus for mobile communication terminals shown in FIG. 1;

FIG. 3 shows how a battery pack according to the present invention is mounted to a mobile communication terminal, wherein

FIG. 3a is a rear view of the mobile communication terminal with the battery pack mounted thereto, and

FIG. 3b is a side view, in cross section, of the mobile communication terminal shown in FIG. 3a;

FIG. 4 shows how the battery pack according to the present invention is separated from the mobile communication terminal, wherein

FIG. 4a is a rear view of the mobile communication terminal with the battery pack separated therefrom, and

FIG. 4b is a side view, in cross section, of the mobile communication terminal shown in FIG. 4a; and

FIG. 5 is a perspective rear view showing a mobile communication terminal with a conventional battery pack mounted thereto.

### DESCRIPTION OF THE PREFERRED EMBODIMENTS

Now, a preferred embodiment of the present invention will be described in detail with reference to the accompanying drawings.

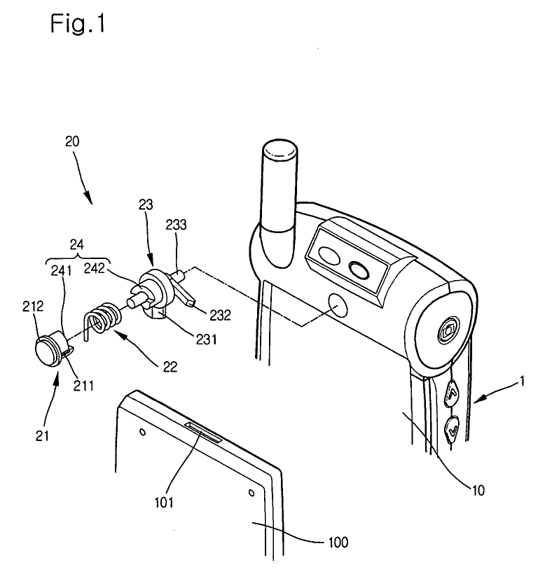

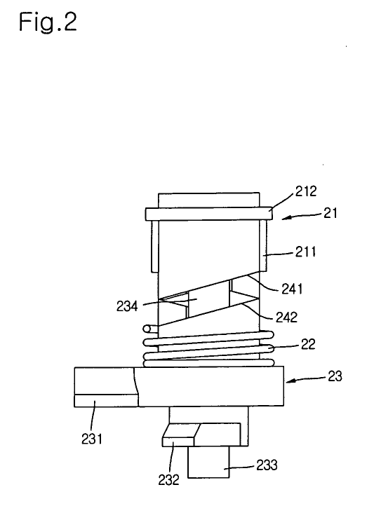

FIG. 1 is an exploded perspective view showing a battery pack mounting apparatus for mobile communication terminals according to a preferred embodiment of the present invention, and FIG. 2 is an enlarged side view of the battery pack mounting apparatus for mobile communication terminals shown in FIG. 1. As shown in FIGS. 1 and 2, a battery pack fitting space 10 is formed at a main body 1 of a mobile communication terminal. In the battery pack fitting space 10 is fitted a battery pack 100, which is fixed to the main body 1 by means of an engagement groove 101 formed at the upper end of the battery pack 100. The battery pack 100 is detachably mounted to the main body 1 of the mobile communication terminal by means of a battery pack mounting apparatus according to the present invention, which is provided at the main body 1 above the battery pack fitting space.

The battery pack mounting apparatus according to the present invention comprises: a push button 21 formed at the main body 1 such that the push button 21 can be pressed in a direction perpendicular to the main body 1; and a rotary locking unit 20 rotatable by an operation of the push button 21 for locking the battery pack 100 to the battery pack fitting space 10 or unlocking the battery pack 100 from the battery pack fitting space 10.

The rotary locking unit 20 comprises: a resilient member 22 for resiliently supporting the push button 21 so that the push button 21 can be repeatedly operated; an actuating member 23 for locking the battery pack 100 to the battery pack fitting space 10 or unlocking the battery pack 100 from the battery pack fitting space 10 according to a forward/backward movement of the push button 21; and a rotary member 24 for rotating the actuating member 23 on the basis of the forward/backward movement of the push button 21.

The push button 21 has a front part protruded from the outside of the main body 1 such that a user can easily and conveniently press the push button 21. The push button 21 is provided at a prescribed position of the lateral part thereof with a guide protrusion 211, which extends in the direction in which the push button 21 is pressed. At the inside surface of the main body 1, to which the push button 21 is attached, is formed a guide groove (not shown), in which the guide protrusion 211 of the push button 21 is slidably inserted so that the push button 21 can be stably and securely moved forward and backward.

The push button 21 is preferably provided at the outer circumference thereof with a stopper 212 for preventing the push button 21 from being separated out of the main body 1 after the push button 21 is fitted in the main body 1.

The resilient member 22 has one end fixed to the push button 21 and the other end fixed to the actuating member 23, which will be described below. Preferably, the resilient member 22 may be a torsion spring. The actuating member 23 is rotated in the direction in which the battery pack is unlocked by means of the resilient member 22 when the push button 21 is pressed. The actuating member 23 is returned to its original position by means of the resilient member 22 when the push button 21 is released.

The actuating member 23 has a rotary shaft 233 formed at the rear part thereof such that the rotary shaft 233 can be rotatably inserted in the main body 1, and an engagement protrusion 231 formed at a prescribed position of the outer circumference thereof such that the engagement protrusion 231 can be engaged in the engagement groove 101 of the battery pack 100 through a rotating movement of the actuating member 23 to mount the battery pack 100 to the main body 1 or separate the battery pack 100 from the main body 1. The actuating member 23 is rotated in a locking or unlocking direction according to the forward or backward movement of the push button 21, whereby the battery pack 100 is mounted to the main body 1 or is separated from the main body 1.

At the actuating member 23 between the engagement protrusion 231 and the rotary shaft 233 is formed a separation protrusion 232, which extends outward while being spaced apart by a prescribed angle. The separation protrusion 232 is accommodated in the inside of the main body 1 while the push button 21 is not pressed. When the push button 21 is pressed, the separation protrusion 232 is rotated along with the actuating member 23. As a result, the separation protrusion 232 is moved toward the battery pack fitting space 10 to push the battery pack 100 forward. Consequently, the battery pack 100 is separated from the main body 1.

At the front part of the actuating member 23 is formed a guide shaft 234, on which the push button 21 is fitted. Separation of the push button 21 from the actuating member 23 is effectively prevented by means of the guide shaft 234 when the push button is moved forward/backward and the actuating member is rotated.

The rotary member 24, which is provided between the front part of the actuating member 23 and the rear part of the push button 21, has a reciprocating inclined surface 241 formed at the rear part of the push button 21 and a rotating inclined surface 242 formed at the front part of the actuating member 23 such that the rotating inclined surface 242 corresponds to the reciprocating inclined surface 241.

When the push button 21 is pressed against the resilient force of the resilient member 22, the reciprocating inclined surface 241 is moved backward to push the rotating inclined surface 242 so that the actuating member 23 can be rotated against the resilient force of the resilient member 22. In this way, the linear movement can be easily converted to rotary movement.

Preferably, the reciprocating inclined surface 241 comprises a plurality of reciprocating inclined surface parts, and the rotating inclined surface 242 also comprises a plurality of rotating inclined surface parts. In this case, the rotation of the actuating member 23, which is accomplished when the push button 21 is pressed once, can be controlled on the basis of the number of the reciprocating inclined surface parts 241 and the rotating inclined surface parts 242. The angle at which the engagement protrusion 231 and the separation protrusion 232 are spaced apart from each other can also be controlled on the basis of the number of the reciprocating inclined surface parts 241 and the rotating inclined surface parts 242.

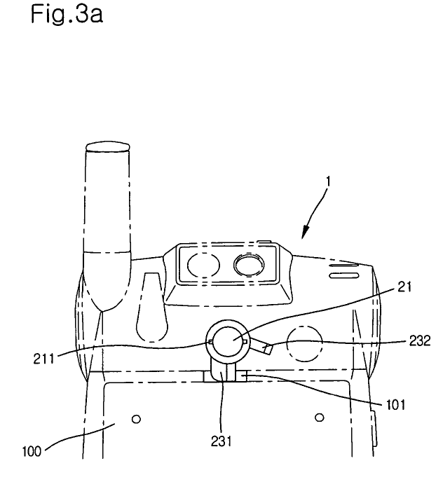

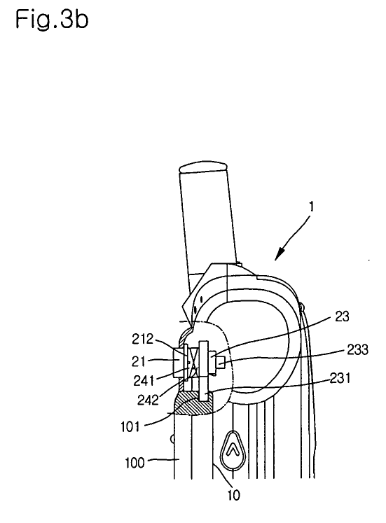

FIG. 3 shows how the battery pack according to the present invention is mounted to the mobile communication terminal. Specifically, FIG. 3a is a rear view of the mobile communication terminal with the battery pack mounted thereto, and FIG. 3b is a side view, in cross section, of the mobile communication terminal shown in FIG. 3a.

When the battery pack is fitted in the battery pack fitting space 10 while the resilient member 22 is disposed in the direction in which the engagement protrusion 231 formed at the actuating member 23 is constantly engaged in the engagement groove 101 of the battery pack 100 as shown in FIG. 3, the actuating member 23 is rotated by means of an inclined surface formed at the engagement protrusion 231 so that the engagement protrusion 231 is moved toward the inside of the main body 1. As the battery pack 100 is completely fitted in the battery pack fitting space 10, the actuating member 23 is resiliently rotated, whereby the battery pack 100 is securely mounted to the main body 1.

Preferably, the battery pack fitting space is provided with a plurality of grooves, and the battery pack is provided at one side thereof opposite to the battery pack fitting space with a plurality of protrusions such that the protrusions correspond to the grooves, respectively. The battery pack 100 can be securely mounted to the main body 1 by means of the protrusions and the corresponding grooves, whereby the battery pack 100 is easily separated from the main body 1 when an external force is applied to the battery pack 100.

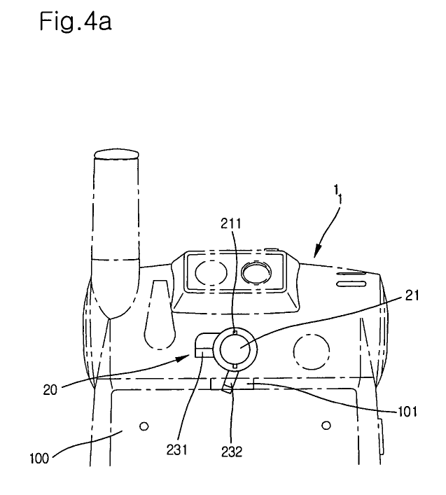

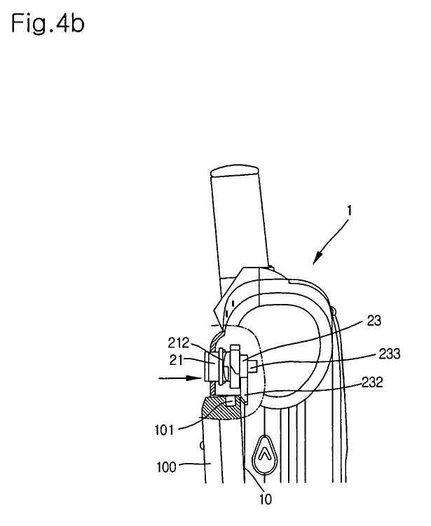

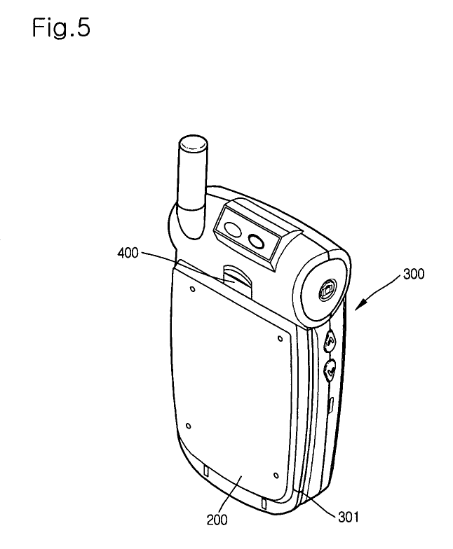

FIG. 4 shows how the battery pack according to the present invention is separated from the mobile communication terminal. Specifically, FIG. 4a is a rear view of the mobile communication terminal with the battery pack separated therefrom, and FIG. 4b is a side view, in cross section, of the mobile communication terminal shown in FIG. 4a.

When the push button 21 is pressed to separate the battery pack 100 from the main body 1, the actuating member 23 is rotated by means of the rotary member 24, and the engagement protrusion 231 is rotated toward the inside of the main body 1. As a result, the battery pack 100 is released.

When the battery pack 100 is released, the actuating member 23 is continuously rotated against the resilient force of the resilient member 22 so that the separation protrusion 232 is moved into the battery pack fitting space 10. Simultaneously, the battery pack 100 is pushed forward by means of the resilient force of the resilient member 22, and therefore the battery pack 100 is separated from the main body 1.

When an external force applied to the push button 21 is removed after the battery pack 100 is completely separated from the battery pack fitting space 10, the actuating member 23 is rotated to its original position by means of a resilient force of the resilient member 22. In this way, the separation of the battery pack 100 from the main body 1 is accomplished.

As described above, the battery pack 100 can be easily separated from the main body 1 by simply pressing the push button 21. Consequently, the separating operation of the battery pack 100 from the main body 1 can be carried out using only one hand of a user, whereby more convenient replacement of the battery pack 100 is accomplished.

As apparent from the above description, the present invention provides a battery pack mounting apparatus for mobile communication terminals that is capable of separating a battery pack from a main body of a mobile communication terminal by simply pressing a push button formed at the main body of the mobile communication terminal. Consequently, the present invention has an effect that separation of the battery pack can be more easily and conveniently achieved.

Furthermore, the battery pack mounting apparatus has a separation protrusion, by which the battery pack is separated from the main body simultaneously when the battery pack is released. Consequently, separation of the battery pack is more easily accomplished. In addition, the battery pack can be easily separated from the main body with only one hand of a user.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A battery pack mounting apparatus for mobile communication terminals, comprising:
a push button; and
a rotary locking unit rotatable by an operation of the push button for locking a battery pack to a battery pack fitting space or unlocking the battery pack from the battery pack fitting space.

2. The apparatus as set forth in claim 1, wherein the push button is slidably mounted to the main body, and the apparatus further comprises:
means for guiding a sliding movement of the push button.

3. The apparatus as set forth in claim 2, wherein the guiding means comprises:
a guide protrusion provided at a lateral part of the push button; and
a guide groove provided at an inside surface of the main body to receive the guide protrusion.

4. The apparatus as set forth in claim 3, wherein the push button is provided at the outer circumference thereof with a stopper for preventing the push button from being separated out of the main body.

5. The apparatus as set forth in claim 1, wherein the battery pack fitting space is provided with a plurality of grooves, and the battery pack is provided at one side thereof opposite to the battery pack fitting space with a plurality of protrusions such that the protrusions correspond to the grooves, respectively.

6. The apparatus as set forth in claim 1, wherein the rotary locking unit comprises:
an actuating member for locking the battery pack to the battery pack fitting space or unlocking the battery pack from the battery pack fitting space according to a movement of the push button;
a rotary member for rotating the actuating member between a locking position and an unlocking position on the basis of the movement of the push button; and
a resilient member disposed at the rear of the push button for resiliently supporting the push button and returning the actuating member to its original position.

7. The apparatus as set forth in claim 6, wherein the resilient member is fitted on the front outer circumference of the actuating member, the resilient member having one end supporting the inside surface of the main body and the other end fixed to the actuating member.

8. The apparatus as set forth in claim 7, wherein the resilient member is a torsion spring.

9. The apparatus as set forth in claim 6, wherein the actuating member has a rotary shaft formed at the rear part thereof such that the rotary shaft can be rotatably inserted in the main body, a guide shaft formed at the front part thereof, the guide shaft being inserted in the push button for preventing separation of the push button from the actuating member, and an engagement protrusion formed at a prescribed position of the outer circumference thereof such that the engagement protrusion can be engaged in an engagement groove formed at the battery pack.

10. The apparatus as set forth in claim 6, wherein the rotary member has a reciprocating inclined surface formed at the rear part of the push button and a rotating inclined surface formed at the front part of the actuating member such that the rotating inclined surface corresponds to the reciprocating inclined surface.

11. The apparatus as set forth in claim 10, wherein the reciprocating inclined surface comprises a plurality of reciprocating inclined surface parts, and the rotating inclined surface comprises a plurality of rotating inclined surface parts.

12. The apparatus as set forth in claim 11, wherein the rotation of the actuating member accomplished when the push button is pressed once is controlled on the basis of the number of the reciprocating inclined surface parts and the rotating inclined surface parts.

13. The apparatus as set forth in claim 6, wherein the actuating member is provided at a prescribed position of the rear part thereof with a separation protrusion such that the separation protrusion extends outward while being spaced apart from the engagement protrusion by a prescribed angle, the separation protrusion being moved toward the battery pack fitting space as the actuating member is rotated so that the battery pack is separated from the battery pack fitting space.

14. The apparatus as set forth in claim 13, wherein the angle between the engagement protrusion and the separation protrusion is controlled on the basis of the number of the reciprocating inclined surface parts and the rotating inclined surface parts.
